(19) United States
(12) Patent Application Publication
(10) Pub. No.: US 2024/0103641 A1
(43) Pub. Date: Mar. 28, 2024

(54) KEYBOARD HOUSINGS WITH FLEXIBLE TOUCH SENSING COMPONENTS

(71) Applicant: Hewlett-Packard Development Company, L.P., Spring, TX (US)

(72) Inventors: Cheng-Han Tsai, Taipei City (TW); Midas Wu, Taipei City (TW); Wen-Hung Wang, Taipei City (TW)

(73) Assignee: Hewlett-Packard Development Company, L.P., Spring, TX (US)

(21) Appl. No.: 17/768,898

(22) PCT Filed: Nov. 6, 2019
(86) PCT No.: PCT/US2019/059952

§ 371 Date: Apr. 14, 2022

(51) Int. Cl. G06F 3/02; G06F 1/16; G06F 3/0354

(52) U.S. Cl. CPC G06F 3/0213; G06F 1/1666; G06F 1/169; G06F 3/03547

(57) ABSTRACT

In one example, a keyboard housing may include a chassis, a plurality of keys exposed through a top surface of the chassis, and an input device assembly connected to the chassis. The input device assembly may include a flexible touch sensing component to receive a touch input and a support structure. The support structure may include a first portion and a second portion foldable onto the first portion. The first portion and the second portion may support the flexible touch sensing component.

### BACKGROUND

The emergence and popularity of mobile computing has made portable electronic devices, due to their compact design and light weight, a staple in today's marketplace. Within the mobile computing realm, electronic devices such as notebook computers, laptops, personal digital assistants, and the like may be widely used and may employ a clamshell-type design including two housings connected at a common end via hinges. For example, a first or display housing may be utilized to provide a viewable display while a second or base housing may include an area for interface components (e.g., a keyboard, a touchpad, and other input devices). Further, convertible touchscreen notebook computers may represent a hybrid-type device that includes a base housing for enabling standard Input (e.g., a keyboard and a touchpad) along with an attached touchscreen display housing for accepting user input and displaying images.

### BRIEF DESCRIPTION OF THE DRAWINGS

Examples are described in the following detailed description and in reference to the drawings, in which:

FIG. 1A is a perspective view of an example keyboard housing, depicting a support structure to fold or unfold a flexible touch sensing component;

FIG. 1B is a perspective view of the example keyboard housing of FIG. 1A, depicting additional features;

FIG. 1C is a cross sectional side view of a portion of the example keyboard housing of FIG. 1A, depicting an open position of the support structure to unfold the flexible touch sensing component;

FIG. 2A is a perspective view of an example keyboard housing, including a cut-away section to depict a connection between an input device assembly and a first circuit board of the keyboard housing;

FIG. 2B is a perspective view of the example keyboard housing of FIG. 2A, depicting additional features;

FIG. 3A is a perspective view of an example electronic device, depicting a support structure to fold or unfold a flexible touch sensing component;

FIG. 3B is a perspective view of the example electronic device of FIG. 3A, including a cut-away section to depict a connection between an input device assembly and a motherboard of a keyboard housing; and

FIG. 3C is a cross sectional side view of the example electronic device of FIG. 3A, depicting a closed position of the support structure to fold the flexible touch sensing component.

### DETAILED DESCRIPTION

Electronic devices, such as portable computers, may employ a clamshell-type design with two housings connected at a common end via hinges. The two housings can be rotatable relative to one another between an open position and a closed position. For example, a first or display housing may house a display (e.g., a liquid crystal display (LCD)) and a second or base housing may house interface components (e.g., a keyboard, a touchpad, and other input devices). Further, the hinges may rotatably, detachably, or twistably couple the first or display housing with the second or base housing.

Electronic devices may utilize touchpads for receiving user inputs. A touchpad may be a human input interface having a tactile sensing surface that may translate a motion or a position of user's finger(s) into spatial data, for instance, to control a pointer or cursor displayed on a computer screen. Further, the touchpad may have a switch that allows a user to depress the tactile surface to provide a click input. However, such touchpads may not support other functions such as drawing, writing, and the like. Also, the tactile sensing surface of such touchpads may be limited in size and hence may affect user experience.

Examples described herein may provide a flexible touch sensing component for a keyboard housing. The keyboard housing may include an input device assembly having the flexible touch sensing component to receive a touch input. Example flexible touch sensing component may include a silver nanowire film. Further, the input device assembly may include a support structure to support the flexible touch sensing component. The support structure may include a first portion and a second portion foldable onto the first portion, for instance, via a hinge to fold or unfold the flexible touch sensing component.

Thus, examples described herein may utilize the flexible touch sensing component, such as the silver nanowire film, in a clickpad or touchpad to facilitate a foldable touch sensing component for keyboard housings. The foldable touch sensing component may provide a significant amount of space for users to perform functions such as drawing and/or writing on the keyboard housings. Further, the flexible touch sensing components described herein may enable users to take notes directly on the notebook computers. Also, the foldable structure described herein may protect a touch area of the flexible touch sensing component and also prevent inadvertent touching of the touch area. In addition, examples described herein may provide a writing solution on the notebook computers without a need for external writing boards, thereby enhancing the user experience. The touch sensor functionality of sliver nanowire film may also achieve a significantly broader writing area based on the footprint, i.e., a size of the writing area may adapt with a size of the notebook computers.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described is included in at least that one example, but not necessarily in other examples.

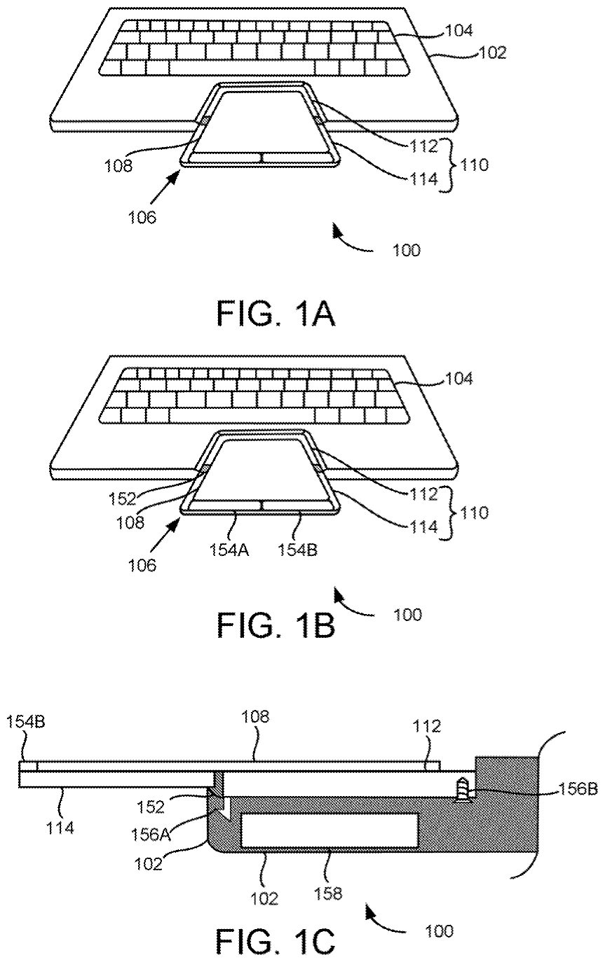

Turning now to the figures, FIG. 1A is a perspective view of an example keyboard housing 100, depicting a support structure 110 to fold or unfold a flexible touch sensing component 108. In one example, keyboard housing 100 may be an input device that can be externally connected to a computer and enables to input data and/or commands into the computer. In other examples, keyboard housing 100 may be a base housing that can be rotatably, detachably, or twistably coupled to a display housing of the computer.

Keyboard housing 100 may include a chassis 102. Example chassis 102 may include a top cover and a bottom cover connected together to form an enclosure to house electronic components such as battery, processor, memory, integrated circuits, and the like. Keyboard housing 100 may include a plurality of keys 104 exposed through a top surface of chassis 102. For example, the top cover may have an opening though which a key can be exposed. In one example, the plurality of keys 104 may be arranged in a QWERTY keyboard layout.

Further, keyboard housing 100 may include an input device assembly 106 connected to chassis 102. Input device assembly 106 may include flexible touch sensing component 108 to receive a touch input. In one example, flexible touch sensing component 108 may provide functionalities of a touchpad or a clickpad to provide touch and/or click inputs to the computer. In addition, flexible touch sensing component 108 may also support drawing and/or writing functions, for instance, via a stylus or a finger.

For example, flexible touch sensing component 108 may be a flexible, formable, bendable, or foldable single-piece structure. Example flexible touch sensing component 108 may be a silver nanowire film. The silver nanowire film may use silver nanowires (AgNWs) for flexible transparent electrodes due to high electrical conductivity, optical transparency, thermal conductivity, and mechanical flexibility. The sliver nanowire film may provide writing area for users.

Furthermore, input device assembly 106 may include support structure 110. As shown in FIG. 1A, support structure 110 may include a first portion 112 and a second portion 114 foldable onto first portion 112. Further, first portion 112 and second portion 114 may support flexible touch sensing component 108. For example, a portion of flexible touch sensing component 108 may be disposed on first portion 112 and a remaining portion of flexible touch sensing component 108 may be disposed on second portion 114. In this example, first portion 112 and second portion 114 can fold or unfold flexible touch sensing component 108.

FIG. 1B is a perspective view of example keyboard housing 100 of FIG. 1A, depicting additional features. For example, similarly named elements of FIG. 16 may be similar in structure and/or function to elements described with respect to FIG. 1A. As shown in FIG. 1B, input device assembly 106 may include a hinge 152 to rotatably connect first portion 112 and second portion 114.

Further, input device assembly 106 may include a first actuator 154A and a second actuator 1546 disposed on second portion 114 and adjacent to flexible touch sensing component 108. In one example, first actuator 154A and second actuator 1546 may perform different functions. For example, first actuator 154A may perform a left click functionality and second actuator 154B may perform a right click functionality. In other examples, input device assembly 106 may include a third actuator to perform a middle click functionality that can be different from the left click functionality and the right click functionality.

FIG. 1C is a cross sectional side view of a portion of example keyboard housing 100 of FIG. 1A, depicting an open position of support structure 110 to unfold flexible touch sensing component 108. For example, similarly named elements of FIG. 1C may be similar in structure and/or function to elements described with respect to FIG. 1A. As shown in FIG. 1C, chassis 102 may house an electronic component 158 such as the battery. Further, first portion 112 may be fixedly connected to chassis 102 using a fastener such as a hook 156A and/or a screw 156B, Furthermore, second portion 114 can be rotatable relative to first portion 112 to fold or unfold flexible touch sensing component 108, During operation, hinge 152 may facilitate rotation between first portion 112 and second portion 114 in an angular range of between 0 degrees (i.e., flexible touch sensing component 108 in a folded position) and about 180 degrees (i.e., flexible touch sensing component 108 in an unfolded position, as shown in FIG. 1C),

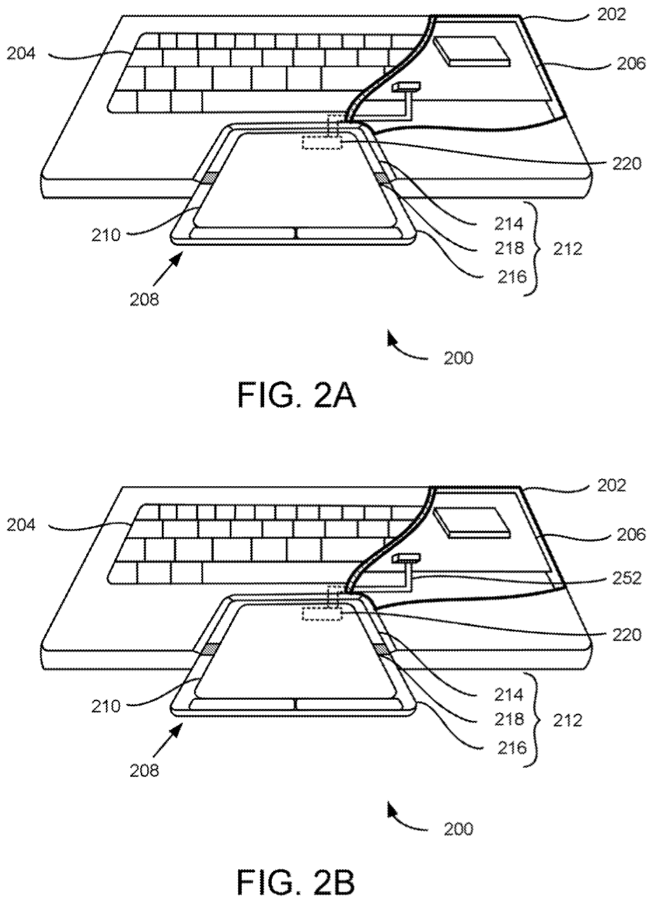

FIG. 2A is a perspective view of an example keyboard housing 200, including a cut-away section to depict a connection between an input device assembly 208 and a first circuit board 206 of keyboard housing 200. Example keyboard housing 200 may include a chassis 202, a plurality of keys 204 exposed through a top surface of chassis 202, and first circuit board 206 connected to chassis 202. For example, first circuit board 206 may be a motherboard.

Further, keyboard housing 200 may include input device assembly 208 disposed within chassis 202 and exposed through the top surface of chassis 202. Input device assembly 208 may be a mouse-like input device located at a base of a keyboard (i.e., keys 204). Input device assembly 208 may include a flexible touch sensing component 210 to receive a touch input. Example flexible touch sensing component 210 may be a silver nanowire film. Further, input device assembly 208 may include a support structure 212 to hold flexible touch sensing component 210.

Support structure 212 may include a first portion 214, a second portion 216, and a hinge 218. In one example, hinge 218 may rotatably or pivotally connect first portion 214 and second portion 216 between an open position to unfold flexible touch sensing component 210 and a closed position to fold flexible touch sensing component 210. In the open position, second portion 216 may extend beyond a periphery of chassis 202.

Further, input device assembly 208 may include a second circuit board 220 (e.g., a driver board) to electrically connect with flexible touch sensing component 210 and first circuit board 206. In one example, second circuit board 220 may be disposed in support structure 212 below flexible touch sensing component 210, Hinge 218 may facilitate rotation between first portion 214 and second portion 216 in an angular range of between 0 degrees and about 180 degrees. For example, flexible touch sensing component 210 may have a thickness of about 1 mm, support structure 212 may have a thickness of about 3 mm, and second circuit board 220 may have a thickness of about 32 mm,

FIG. 2B is a perspective view of example keyboard housing 200 of FIG. 2A, depicting additional features. For example, similarly named elements of FIG. 2B may be similar in structure and/or function to elements described with respect to FIG. 2A. As shown in FIG. 2B, keyboard housing 200 may include a flexible printed circuit (FPC) cable 252 to electrically connect second circuit board 220 and first circuit board 206. In one example, FPC cable 252 may have a first end connected to first circuit board 206 via a first FPC connector disposed on first circuit board 206. Further, FPC cable 252 may have a second end connected to second circuit board 220 via a second FPC connector disposed on second circuit board 220. The cut-away section of a portion of keyboard housing 200 may depict first circuit board 206 and FPC cable 252 connected to first circuit board 206.

During operation, second circuit board 220 may transmit input information (e.g., touch inputs and/or click inputs) from input device assembly 208 to first circuit board 206 (i.e., the motherboard) which executes instructions upon receiving the input information from input device assembly 208. Further, first circuit board 206 may control content displayed on a display according to the input information. In other examples, input device assembly 208 may also be provided with haptic feedback modules for generating a haptic feedback via flexible touch sensing component 210 in response to the touch input.

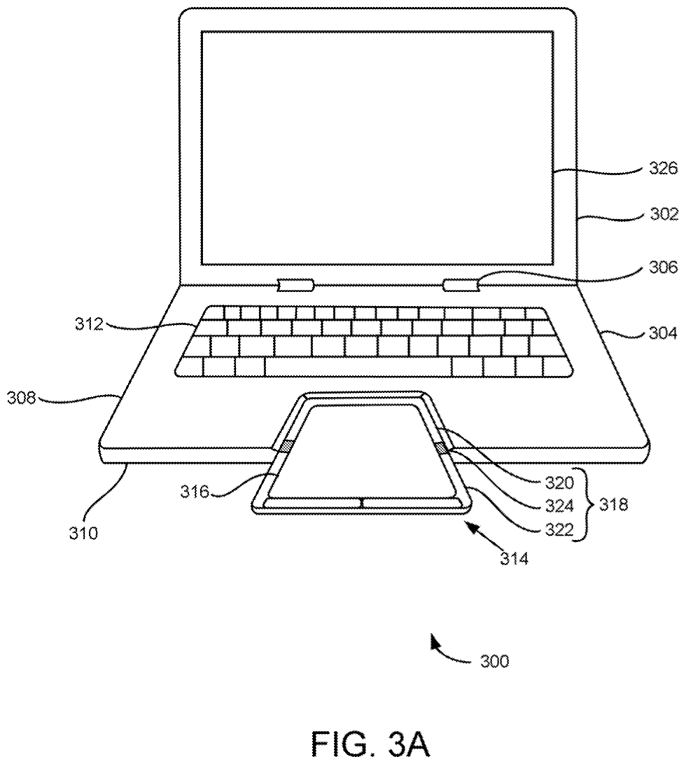

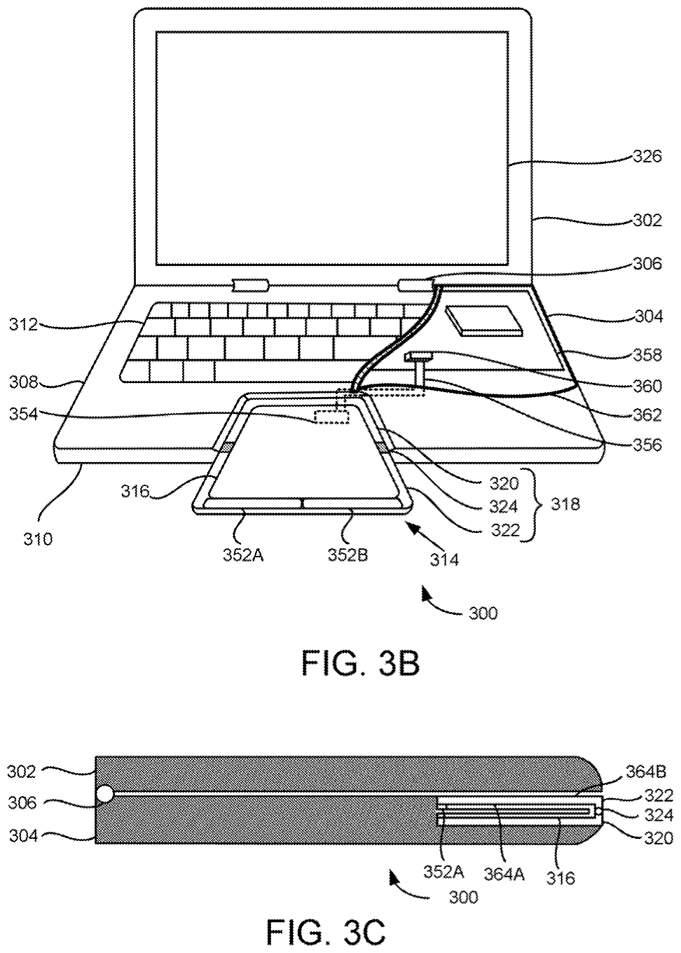

FIG. 3A is a perspective view of an example electronic device 300, depicting a support structure 318 to fold or unfold a flexible touch sensing component 316. Example electronic device 300 may be a personal computer, a notebook computer, a tablet computer, a convertible device, a personal gaming device, and the like. Example convertible device may refer to a device that can be “convertible” from a laptop mode to a tablet mode.

Electronic device 300 may include a display housing 302, a keyboard housing 304, and a hinge 306 to connect display housing 302 and keyboard housing 304. In one example, hinge 306 may rotatably, detachably, or twistably connect display housing 302 and keyboard housing 304. Display housing 302 may house a display panel 326 (e.g., a touchscreen display). Example display panel 326 may include liquid crystal display (LCD), light emitting diode (LED) display, electro-luminescent (EL) display, or the like. Keyboard housing 304 may house a keyboard (e.g., keys 312), battery, and the like. Electronic device 300 may also be equipped with other components such as a camera, audio/video devices, and the like depending on the functions of electronic device 300.

Further, keyboard housing 304 may include a top cover 308 and a bottom cover 310 connected together to form an enclosure to house electronic components such as battery, processor, memory, integrated circuits, and the like. Furthermore, keyboard housing 304 may include a plurality of keys 312 exposed through top cover 308.

Also, keyboard housing 304 may include an input device assembly 314 exposed through top cover 308. Further, input device assembly 314 may be disposed within the enclosure and exposed through an opening in top cover 308. In one example, input device assembly 314 may be operably connected to display panel 326.

Input device assembly 314 may include flexible touch sensing component 316 and support structure 318 to hold flexible touch sensing component 316. Example flexible touch sensing component 316 may be a silver nanowire film. Further, support structure 318 may include a first portion 320, a second portion 322, and a hinge 324. In one example, second portion 322 may be foldable onto first portion 320 via hinge 324. In this example, first portion 320 and second portion 322 may support/hold flexible touch sensing component 316 such that flexible touch sensing component 316 can be folded when second portion 322 is folded onto first portion 320.

In one example, first portion 320 and second portion 322 can be rotatable relative to one another between an open position and a closed position of input device assembly 314. The term “closed position” may refer to a configuration in which first portion 320 is facing second portion 322 (i.e., the two portions are in parallel) and flexible touch sensing component 316 may not be available for user access. The term “open position” may refer to a configuration in which first portion 320 and second portion 322 are not parallel and flexible touch sensing component 316 can be available for user access.

FIG. 38 is a perspective view of example electronic device 300 of FIG. 3A, including a cut-away section 362 to depict a connection between input device assembly 314 and a motherboard 358 of keyboard housing 304. Similarly named elements of FIG. 38 may be similar in structure and/or function to elements described with respect to FIG. 3A. As shown in FIG. 38, input device assembly 314 may include a first actuator 352A and a second actuator 3528 disposed on second portion 322 and adjacent to flexible touch sensing component 316. First actuator 352A and second actuator 3528 may perform different functions. For example, first actuator 352A and second actuator 352B may be left and right click input buttons, respectively.

Further input device assembly 314 may include a circuit board 354 electrically connected to flexible touch sensing component 316. Also, input device assembly 314 may include a flexible printed circuit (FPC) cable 356 to electrically connect circuit board 354 to motherboard 358 of keyboard housing 304, for instance, via an FPC connector 360 disposed on motherboard 358. In one example, flexible touch sensing component 316 may be operably connected to display panel 326 using circuit board 354. During operation, input device assembly 314 may provide touch driving, sensing, processing, and/or communication functionalities to determine a touch input and send touch input information to motherboard 358 (e.g., to a processing unit of motherboard 358). Further, motherboard 358 may control the content displayed by display panel 326 according to the touch input information.

In one example, first portion 320 may be fixedly connected to top cover 308 or bottom cover 310, and second portion 322 may be rotated relative to first portion 320 via hinge 324 between the open position to unfold flexible touch sensing component 316 and the closed position to fold flexible touch sensing component 316.

FIG. 3C is a cross sectional side view of example electronic device 300 of FIG. 3A, depicting the closed position of support structure 318 to fold flexible touch sensing component 316. Similarly named elements of FIG. 3C may be similar in structure and/or function to elements described with respect to FIG. 3A. Hinge 324 may facilitate rotation between first portion 320 and second portion 322 in an angular range of between 0 degrees (i.e., flexible touch sensing component 316 in a folded position, as shown in FIG. 3C) and about 180 degrees (i.e., flexible touch sensing component 316 in an unfolded position).

In other examples, input device assembly 314 may be provided with another touchpad or clickpad on a backside of support structure 318, such that the touchpad or the clickpad can be accessed when support structure 318 is in the folded position. As shown in FIG. 3C, a portion of flexible touch sensing component 316 may be disposed on a first surface of first portion 320 and a remaining portion of flexible touch sensing component 316 may be disposed on a first surface 364A of second portion 322 such that flexible touch sensing component 316 can be accessed when support structure 318 is in the unfolded position. Further, the touchpad or the clickpad can be provided on a second surface 364B of second portion 322 (e.g., a top surface of second portion 322 as shown in FIG. 3C) such that the touchpad or the clickpad can be accessed when support structure 318 is in the folded position. In this example, second surface 3648 may be opposite to first surface 364A.

It may be noted that the above-described examples of the present solution are for the purpose of illustration only. Although the solution has been described in conjunction with a specific implementation thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract, and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on,” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A keyboard housing comprising:
a chassis;
a plurality of keys exposed through a top surface of the chassis; and
an input device assembly connected to the chassis, the input device assembly comprising:
a flexible touch sensing component to receive a touch input; and
a support structure comprising:
a first portion; and
a second portion foldable onto the first portion, wherein the first portion and the second portion are to support the flexible touch sensing component.

2. The keyboard housing of claim 1, wherein the input device assembly further comprises:
a hinge to rotatably connect the first portion and the second portion.

3. The keyboard housing of claim 1, wherein the input device assembly further comprises:
a first actuator and a second actuator disposed on the second portion and adjacent to the flexible touch sensing component, wherein the first actuator and the second actuator perform different functions.

4. The keyboard housing of claim 1, wherein the first portion is fixedly connected to the chassis using a fastener.

5. The keyboard housing of claim 1, wherein the flexible touch sensing component is a silver nanowire film.

6. A keyboard housing comprising:
a chassis;
a plurality of keys exposed through a top surface of the chassis;
a first circuit board connected to the chassis; and
an input device assembly disposed in the chassis and exposed through the top surface, the input device assembly comprising:
a flexible touch sensing component to receive a touch input;
a support structure to hold the flexible touch sensing component, the support structure comprising:
a first portion;
a second portion; and
a hinge to rotatably connect the first portion and the second portion between an open position to unfold the flexible touch sensing component and a closed position to fold the flexible touch sensing component; and
a second circuit board to electrically connect with the flexible touch sensing component and the first circuit board.

7. The keyboard housing of claim 6, further comprising:
a flexible printed circuit (FPC) cable to electrically connect the second circuit board and the first circuit board.

8. The keyboard housing of claim 6, wherein the hinge is to facilitate rotation between the first portion and the second portion in an angular range of between 0 degrees and about 180 degrees.

9. The keyboard housing of claim 6, wherein the first circuit board is a motherboard.

10. The keyboard housing of claim 6, wherein the flexible touch sensing component is a silver nanowire film.

11. An electronic device comprising:
a display housing having a display panel;
a keyboard housing; and
a first hinge to connect the keyboard housing and the display housing, the keyboard housing comprising:
a top cover;
a bottom cover;
a plurality of keys exposed through the top cover; and
an input device assembly exposed through the top cover, the input device assembly comprising:
a flexible touch sensing component; and
a support structure to hold the flexible touch sensing component, the support structure comprising:
a first portion;
a second portion; and
a hinge, wherein the second portion is foldable onto the first portion via the hinge, and wherein the first portion and the second portion are to support the flexible touch sensing component.

12. The electronic device of claim 11, wherein the first portion is fixedly connected to the top cover or the bottom cover, and wherein the second portion is rotated relative to the first portion via the hinge between an open position to unfold the flexible touch sensing component and a closed position to fold the flexible touch sensing component.

13. The electronic device of claim 11, wherein the input device assembly further comprises:
a first actuator and a second actuator disposed on the second portion and adjacent to the flexible touch sensing component, wherein the first actuator and the second actuator perform different functions.

14. The electronic device of claim 11, wherein the input device assembly further comprises:
a circuit board electrically connected to the flexible touch sensing component; and
a flexible printed circuit (FPC) cable to electrically connect the circuit board to a motherboard of the keyboard housing.

15. The electronic device of claim 11, wherein the flexible touch sensing component is a silver nanowire film.
